(19) United States
(12) Patent Application Publication
(10) Pub. No.: US 2025/0310448 A1
(43) Pub. Date: Oct. 2, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Kojiro OISHI, Kanagawa (JP)

(73) Assignee: FUJIFILM Business Innovation Corp., Tokyo (JP)

(21) Appl. No.: 18/773,915

(22) Filed: Jul. 16, 2024

(30) Foreign Application Priority Data
Mar. 27, 2024 (JP) 2024-052208

(51) Int. Cl. H04N 1/00

(52) U.S. Cl. CPC H04N 1/00395; H04N 1/00381

(57) ABSTRACT

An information processing system includes a processor configured to: in a case where a non-contact operation by a target object is performed on an object within a screen, when the target object is detected in a detection region included in a display region in which the object is displayed within the screen, expand the detection region to outside the display region.

### CROSS-REFERENCE TO RELATED APPLICATIONS

This application is based on and claims priority under 35 USC 119 from Japanese Patent Application No. 2024-052208 filed Mar. 27, 2024.

### BACKGROUND

### (i) Technical Field

The present disclosure relates to an information processing system, a non-transitory computer readable medium, and information processing method.

### (ii) Related Art

Japanese Unexamined Patent Application Publication No. 2013-149049 discloses a touch panel-type input device including a touch panel that displays a keyboard to perform input, a display controller that displays keys on the touch panel, a contact detector that detects a position touched by a finger on the touch panel, an input determiner that determines an input key from the touched position, and a three-dimensional sensor that detects the position of the finger touching or leaving the touch panel and a distance from the touch panel, in which the display controller enlarges and displays a key centered on the position when the three-dimensional sensor detects the approaching finger, and restores the key to a standard size when the input determiner confirms the input of the key.

Japanese Unexamined Patent Application Publication No. 2023-40955 discloses an information processing apparatus including a processor, the processor displays an image including one or more items on a screen, detects a non-contact input to the item from a user, and selects the items corresponding to the detection region when the non-contact input is accepted for a time equal to or longer than a threshold value in the detection region whose area is smaller than the area of the item.

### SUMMARY

Aspects of non-limiting embodiments of the present disclosure relate to continuation of a detection state of a target object, as compared with a configuration in which a detection region stays within a display region when the target object is detected on the detection region included in the display region of an object to be operated in a non-contact manner.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing system including a processor configured to: in a case where a non-contact operation by a target object is performed on an object within a screen, when the target object is detected in a detection region included in a display region in which the object is displayed within the screen, expand the detection region to outside the display region.

### BRIEF DESCRIPTION OF THE DRAWINGS

Exemplary embodiments of the present disclosure will be described in detail based on the following figures, wherein:

FIG. 1 is a diagram illustrating a configuration example of an information processing system including a non-contact user interface with which a user performs an operation in a non-contact manner;

FIG. 2 is a perspective view illustrating a main part of an image processing apparatus according to an exemplary embodiment;

FIG. 3A is a cross-sectional view of an operation panel and FIG. 3B is a plan view of the operation panel as viewed from a position facing a display surface of the operation panel;

FIG. 4 is a diagram illustrating an example of a functional configuration of the image processing apparatus according to the exemplary embodiment;

FIG. 5 is a diagram illustrating a transition example of a screen illustrating how the screen displayed on the operation panel transitions by the operation of the operation panel by the user;

FIG. 6 is a diagram illustrating a selection example in which the user selects a copy button that is an example of an object on a home screen;

FIG. 7 is a block diagram illustrating an example of a main part configuration of an electrical system of the image processing apparatus according to the exemplary embodiment;

FIG. 8 is a front view of a copy screen when the operation panel of the image processing apparatus is viewed from the front;

FIG. 9 is a front view of the copy screen, illustrating a state in which the user's finger is moved onto the object;

FIG. 10 illustrates a state in which a detection region of the object starts to expand in the copy screen of FIG. 9;

FIG. 11 illustrates a state in which the detection region of the object is further expanded in the copy screen of FIG. 10;

FIG. 12 illustrates a state in which the user's finger is moved onto another object within the detection region of the object in the copy screen of FIG. 11;

FIG. 13 illustrates a state in which the user's finger has moved out of the detection region of the object in the copy screen of FIG. 12;

FIG. 14 is a flowchart of an information processing program according to the present exemplary embodiment;

FIG. 15 is a side view illustrating between an operation panel and a user's finger according to another exemplary embodiment; and

FIG. 16 is a plan view illustrating a state in which a detection region of an object is further expanded in a copy screen according to still another exemplary embodiment.

### DETAILED DESCRIPTION

In the following, an example of an exemplary embodiment for carrying out the technique of the present disclosure will be described in detail with reference to the accompanying drawings. Note that constituent elements and processes having the same operations, actions, and functions are denoted by the same reference signs throughout the drawings, and redundant description may be omitted as appropriate. Each drawing is merely schematically illustrated to the extent that the technique of the present disclosure can be sufficiently understood. Therefore, the technique of the present disclosure is not limited to the illustrated examples. In the present exemplary embodiment, a description of a configuration not directly related to the present disclosure or a known configuration may be omitted.

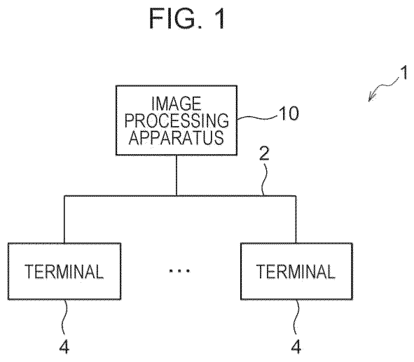

FIG. 1 is a diagram illustrating a configuration example of an information processing system 1 including an information processing apparatus including a non-contact user interface with which a user performs an operation in a non-contact manner.

The information processing apparatus in the information processing system 1 may be an apparatus applied to any field as long as the apparatus includes a non-contact user interface. Examples of the information processing apparatus include an image processing apparatus, an automatic teller machine (ATM), a vending machine, and a ticketing machine. The information processing apparatus may be an apparatus for personal use only or may be an apparatus used by an unspecified large number of users.

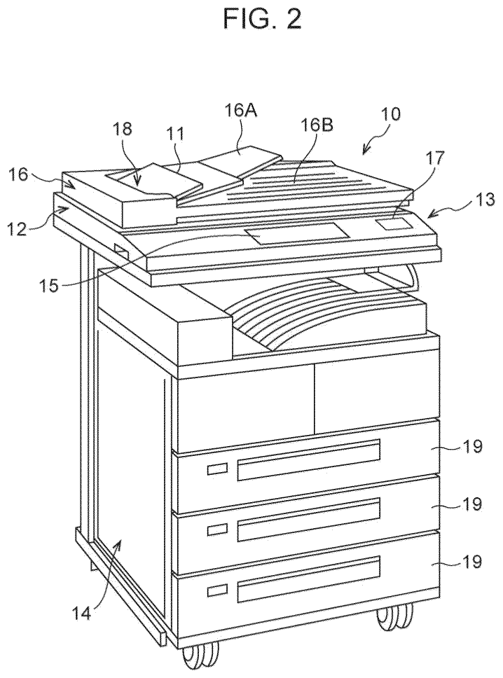

An image processing apparatus 10 installed in a workplace or the like will be described as an example of the information processing apparatus with reference to FIGS. 1 and 2.

FIG. 2 is a perspective view illustrating a main part of the image processing apparatus 10 according to the present exemplary embodiment.

As will be described later, the image processing apparatus 10 is an apparatus that executes a function related to an image in accordance with a user's instruction. The image processing apparatus 10 is connected to, for example, a plurality of terminals 4 used by each of the users via a communication line 2.

The user causes the image processing apparatus 10 to execute desired image processing by transmitting image data generated in the terminal 4 to the image processing apparatus 10 via the communication line 2. Alternatively, the user may store the image data in a portable storage medium such as a universal serial bus (USB) memory or a memory card, move the portable storage medium to the image processing apparatus 10, and connect the portable storage medium to the image processing apparatus 10, thereby causing the image processing apparatus 10 to execute desired image processing. Further, the user may move to the image processing apparatus 10 with a document 11 at least containing one of a character and an image, and cause the image processing apparatus 10 to read the document 11, thereby causing the image processing apparatus 10 to execute the desired image processing.

A connection form of the communication line 2 connecting the image processing apparatus 10 and the terminal 4 is not limited, and may be any form of wired, wireless, or a combination thereof. Furthermore, the number of the terminals 4 connected to the image processing apparatus 10 is also not limited, and for example, none of the terminals 4 may be connected to the image processing apparatus 10.

Note that the terminal 4 is an information device used by the user. The terminal 4 may be any type of information devices as long as the terminal 4 has a data storage function and a data communication function. The terminal 4 includes, for example, a portable terminal that is assumed to be carried and used, such as a smartphone and a wearable device, in addition to a computer that is not assumed to be carried and used.

As illustrated in FIG. 2, the image processing apparatus 10 has, as an example, a scanning function to read an image recorded on a recording medium such as a sheet of paper as image data, a printing function to form an image represented by the image data on a recording medium, and a copying function to form the same image as an image formed on a recording medium on another recording medium. The copying function, the printing function, and the scanning function are examples of image processing in the image processing apparatus 10.

At an upper part of the image processing apparatus 10 illustrated in FIG. 2, for example, a document reading unit 12 is provided, and below the document reading unit 12, an image forming unit 14 is arranged.

The document reading unit 12 includes an optical reading device (not illustrated) and a document transport device 18 in a document cover 16. The document transport device 18 sequentially draws the document 11 placed on a document feeder tray 16A provided in the document cover 16 and transports the documents 11 onto a transported document reading glass (not illustrated). The document reading unit 12 reads the content of the document 11 transported onto the transported document reading glass as image data by the optical reading device. Thereafter, the document transport device 18 ejects the document 11 whose contained content has been read onto a document output tray 16B provided on the document cover 16.

On the other hand, the image forming unit 14 forms an image represented by the image data on the recording medium stored in a storage rack 19 classified for each type and size of the recording medium. Note that the color of the image formed on the recording medium by the image forming unit 14 is not limited, and the image may be a color image or a monochrome image.

At a front of the image processing apparatus 10, an operation display unit 13 that accepts, from a user, operations for performing various functions of the copying function, the printing function, and the scanning function is provided.

Specifically, the operation display unit 13 includes a reader device 17 that acquires information of a user who performs an operation, and an operation panel 15 that accepts an operation of the user.

The reader device 17 is, for example, a device that reads identification information (referred to as a “user ID”) for uniquely identifying a user from an IC chip incorporated in an employee ID card in a non-contact manner when the employee ID card owned by the user is brought close to the reader device 17.

The operation panel 15 is a display on which a touch panel is superimposed, and an object to be operated for executing a function desired by the user is displayed as an icon image on the operation panel 15. The type of the object is not limited as long as the object is to be operated by the user, and the object includes, for example, a button, a scroll bar, a check box, a radio button, and the like. In response to an operation of the user on the object, processing associated in advance with the operation content is executed in the image processing apparatus 10 and a response to the operation is displayed on the operation panel 15.

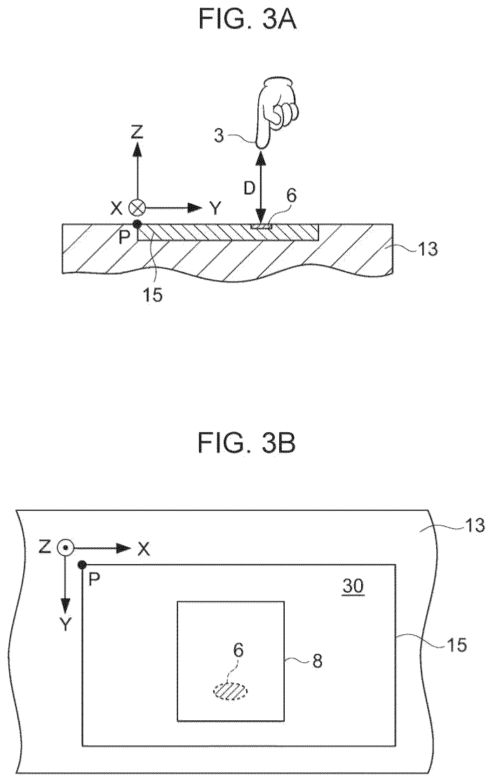

FIGS. 3A and 3B are diagrams illustrating examples of the operation panel 15 that detects an operating position 6 of the user in a non-contact manner. FIG. 3A is a cross-sectional view of the operation panel 15 and FIG. 3B is a plan view of the operation panel 15 as viewed from a position facing a display surface of the operation panel 15.

The operation panel 15 detects a position of a user's finger, that is, the operating position 6 in a non-contact manner. “Detecting the operating position 6 in a non-contact manner” refers to detecting the position of the user's finger simply by holding the finger over a location away from the display surface of the operation panel 15 in a space on the display surface of the operation panel 15 within the range of the display surface of the operation panel 15, without the user pressing the finger against the display surface of the operation panel 15. Hereinafter, the space on the display surface of the operation panel 15 within the range of the display surface of the operation panel 15 is referred to as “on the operation panel 15”. The user “holds a finger over” the operation panel 15 means that the user points the finger on the operation panel 15 without touching the display surface of the operation panel 15.

The operation panel 15 includes a so-called electrostatic capacitance type touch panel that detects the operating position 6 from a change in electrostatic capacitance caused when the user holds a finger over the operation panel 15. In the operation panel 15 including such a touch panel, a change in electrostatic capacitance at a position closest to the user's finger is larger than a change in electrostatic capacitance at other positions. Therefore, the operation panel 15 outputs, as the operating position 6 of the user, a position where the change in electrostatic capacitance is the largest within the range of the operation panel 15.

In order to specify the operating position 6 of the user on the operation panel 15, an operation coordinate system for provisioning a detection region in which the position of the user's finger is detected in a non-contact manner is defined for the operation panel 15. The operation coordinate system is represented as a three-dimensional coordinate system having an origin P at any position on the operation panel 15. In the example of the operation panel 15 illustrated in FIGS. 3A and 3B, the origin P is set at one of the vertices on the outline of the rectangular operation panel 15. Furthermore, in the example of the operation panel 15 illustrated in FIGS. 3A and 3B, with respect to the origin P, an X-axis is set along a lateral direction of the operation panel 15, a Y-axis is set along a longitudinal direction of the operation panel 15, and a Z-axis is set so as to be orthogonal to the X-axis and the Y-axis, respectively. A Z-axis direction is referred to as a height direction of the operation panel 15.

The operating position 6 of the user on the operation panel 15 is represented by a coordinate point (x, y) which is a combination of a coordinate value x of an X-coordinate and a coordinate value y of a Y-coordinate at a location where a change in electrostatic capacitance is the largest within the range of the operation panel 15.

When the object is displayed on the operation panel 15, the object displayed so as to include the operating position 6 of the user is recognized as the object operated by the user. In the example of the operation panel 15 illustrated in FIG. 3B, since the operating position 6 of the user is included in a region of a button 8 arranged in a screen 30 displayed on the operation panel 15, the user is recognized as operating the button 8. Hereinafter, the object displayed so as to include the operating position 6 of the user may be referred to as an “object corresponding to the operating position 6”. Further, the operating position 6 is an example of a “detection position where an operation by the user is detected” according to the present exemplary embodiment.

As illustrated in FIG. 3A, the length of a perpendicular line drawn from a user's finger 3 held over the operation panel 15 to the display surface of the operation panel 15, that is, the distance from the user's finger 3 to the operation panel 15 in the height direction of the operation panel 15 is defined as an “operation distance D”. The user's finger 3 is an example of a target object held by the user. The target object may be a part other than the user's hand or finger, or may be a touch pen or the like owned by the user. On the operation panel 15, as the operation distance D becomes shorter, the change in electrostatic capacitance at the operating position 6 of the user becomes larger. Conversely, on the operation panel 15, as the operation distance D becomes longer, the change in the electrostatic capacitance at the operating position 6 of the user becomes smaller. Therefore, the operation distance D can be obtained from an amount of change in the electrostatic capacitance of the operation panel 15 by previously mapping the relationship between the operation distance D and the amount of change in the electrostatic capacitance.

By using the correspondence relationship between the operation distance D and the amount of change in the electrostatic capacitance, the operation panel 15 can recognize the operating position 6 of the user not only as the two-dimensional operating position 6 along the display surface of the operation panel 15 but also as the three-dimensional operating position 6 in consideration of the operation distance D. That is, when the operating position 6 of the user is three-dimensionally represented, the operating position 6 of the user is represented by a coordinate point (x, y, z) obtained by combining a coordinate value z representing the operating position 6 in the height direction of the operation panel 15 with a coordinate point (x, y). The coordinate value z is a coordinate value of the Z-axis at a position separated from the origin P by the operation distance D along the Z-axis.

When the coordinate value z=0, it means that the user is performing an operation by touching the display surface of the operation panel 15 with a finger. Therefore, the image processing apparatus 10 can also recognize the difference in the operation mode of the user, such as whether or not the user operates the operation panel 15 in a non-contact manner or operates the operation panel 15 in a contact manner with the finger. As described above, the operation panel 15 supports both a contact operation in which the user performs an operation by touching the display surface of the operation panel 15 with the finger and a non-contact operation in which the user performs an operation by holding the finger over the operation panel 15.

As described above, in the operation panel 15, as the operation distance D becomes longer, the change in the electrostatic capacitance at the operating position 6 of the user becomes smaller, and thus there is an upper limit to the operation distance D. Even when the user holds the finger over the operation panel 15 at a position exceeding the upper limit of the operation distance D, the electrostatic capacitance at the operating position 6 of the user does not change, and thus the operation panel 15 does not respond to the operation of the user.

The detection region corresponding to the object is a region in a space, for example, approximately 3 cm away from the operation panel 15. That is, when the user's finger 3 approaches approximately 3 cm from the operation panel 15, the electrostatic capacitance on the object side changes, and thus a non-contact input is detected. At this time, XYZ coordinates of the user's finger 3 in the detection region are acquired as the operating position 6. Next, when the user's finger 3 is brought closer than 3 cm, the XYZ coordinates at that position are acquired.

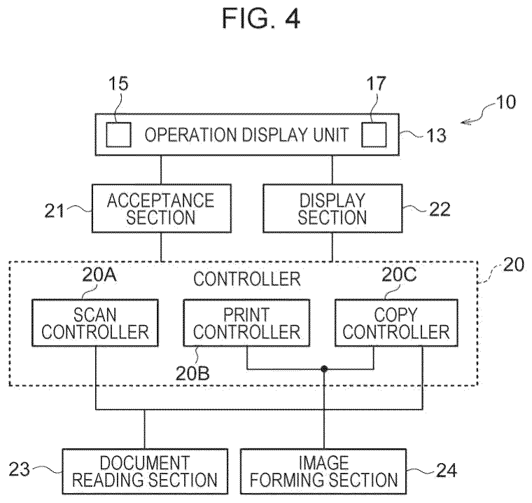

FIG. 4 is a diagram illustrating an example of a functional configuration of the image processing apparatus 10 according to the present exemplary embodiment. The image processing apparatus 10 includes a functional unit and functional sections such as a controller 20, a reception section 21, a display section 22, a document reading section 23, and an image forming section 24.

The reception section 21 accepts a user ID of a user who operates the image processing apparatus 10 from the reader device 17 of the operation display unit 13, and accepts an operating position 6 of the user on the operation panel 15 from the operation panel 15 of the operation display unit 13. The reception section 21 also accepts image data from the terminal 4 or a portable storage medium connected to the image processing apparatus 10. The reception section 21 notifies the controller 20 of the accepted user ID, the operating position 6 of the user, and the image data.

When the user ID is notified from the reception section 21, the controller 20 performs authentication processing of determining whether or not the user represented by the user ID is a user (referred to as a “registered user”) who is permitted to use the image processing apparatus 10. When the controller 20 is notified by the reception section 21 of the user's operating position 6 on the operation panel 15, the controller 20 determines whether or not an object displayed at the user's operating position 6 in the screen 30 displayed on the operation panel 15 is selected, and executes processing associated with the selected object in advance. For example, when the object is the button 8 for starting the printing function, the controller 20 starts the printing function of forming an image represented by the image data accepted by the reception section 21 on a recording medium.

Since the image processing apparatus 10 has the copying function, the printing function, and the scanning function, the controller 20 includes a scan controller 20A for controlling the scanning function, a print controller 20B for controlling the printing function, and a copy controller 20C for controlling the copying function. Control by any of the scan controller 20A, the print controller 20B, and the copy controller 20C is performed according to the content of processing associated with the object operated by the user. Note that although not illustrated, the image processing apparatus 10 may have a facsimile function, and in this case, the controller 20 includes a facsimile controller that controls the facsimile function.

In a case where the operation content of the user via the object is an operation related to the scanning function, the scan controller 20A executes the scanning function by controlling the document reading section 23. In a case where the operation content of the user via the object is an operation related to the printing function, the print controller 20B executes the printing function by controlling the image forming section 24. In a case where the operation content of the user via the object is an operation related to the copying function, the copy controller 20C controls the document reading section 23 to generate image data of the document 11. Thereafter, the copy controller 20C controls the image forming section 24 to form an image represented by the generated image data on a recording medium.

The document reading section 23 drives the document reading unit 12 under the control of the scan controller 20A and the copy controller 20C to, for example, transport the document 11 placed on a document feeder tray 16A and generates image data of the transported document 11.

The image forming section 24 drives the image forming units 14 under the control of the print controller 20B and the copy controller 20C to, for example, transport the recording medium stored in the storage racks 19 and form images represented by the image data on the transported recording medium.

In accordance with an instruction of the controller 20, the display section 22 displays, for example, a result of authentication processing for the user and a result of processing that the controller 20 executed for the user's operation via the object, on the operation panel 15 in the operation display unit 13.

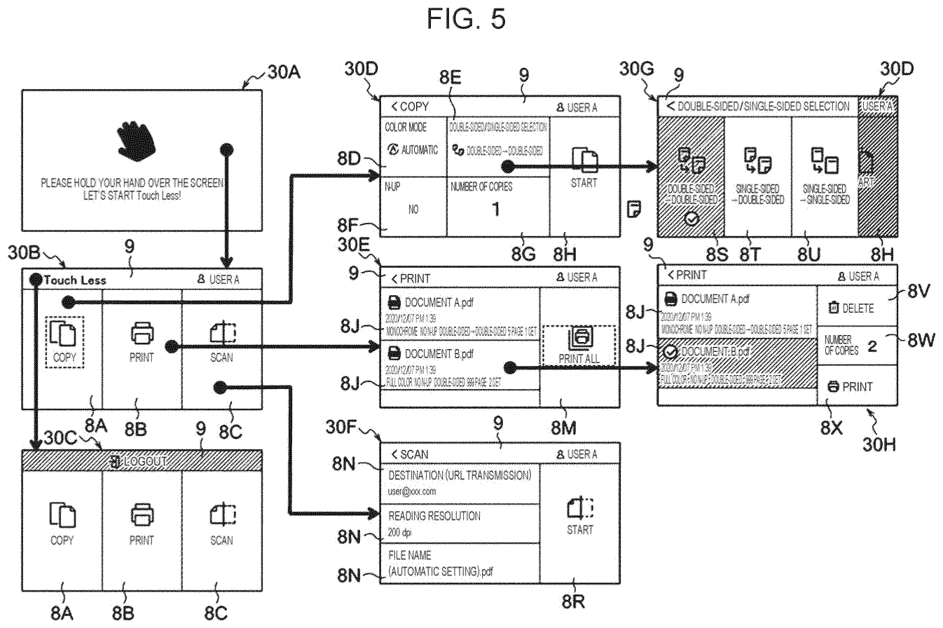

FIG. 5 is a diagram illustrating a transition example of the screen 30 indicating how the screen 30 displayed on the operation panel 15 transitions by the operation of the operation panel 15 by the user.

Note that the display of the screen 30 on the operation panel 15 is performed by the display section 22, but since the display section 22 displays the screen 30 according to an instruction from the controller 20, it can also be said that the controller 20 displays the screen 30 on the operation panel 15. In addition, a space along the Z-axis having a display range of the screen 30 displayed on the operation panel 15 as a bottom surface is referred to as “on the screen 30”, and a space along the Z-axis having a display range of an object displayed in the screen 30 as a bottom surface is referred to as “on the object”. Similarly to the expression “on the operation panel 15”, the expressions “on the screen 30” and “on the object” do not mean the upper side based on the upper, lower, left, and right sides in the real space, but mean a space in a direction facing the screen 30 and a space in a direction facing the object, respectively.

For convenience of explanation, in a case where the types of the screens 30 are distinguished from each other, an alphabet reference sign associated with each type of the screen 30 is appended to the end of the “screen 30”. When it is not necessary to distinguish the types of the screens 30 for description, the respective types of the screens 30 are collectively referred to as the “screen 30”. In addition, in a case where the types of the buttons 8, which are examples of the objects, are distinguished and described, an alphabet reference sign associated with each type of the buttons 8 is appended to the end of the “button 8”. When it is not necessary to distinguish between the types of the buttons 8 for description, each type of the buttons 8 is collectively referred to as the “button 8”.

When the controller 20 determines, through the authentication processing, that the user performing the operation is a registered user, the controller 20 displays a start screen 30A on the operation panel 15. On the start screen 30A, for example, “Please hold your hand over the screen. Let's start Touch Less!” is displayed as an instruction to the user.

When the user holds the finger over the start screen 30A, a cursor is displayed at the operating position 6 of the user on the start screen 30A. In the example of the start screen 30A illustrated in FIG. 5, a cursor in the shape of a hand is displayed, but the shape of the cursor is merely an example, and for example, a circular cursor may be displayed. When the user holds a finger over the start screen 30A, a home screen 30B is displayed. Note that the instruction to the user on the start screen 30A also has a meaning of teaching the user an operation method on the operation panel 15.

On the home screen 30B, for example, buttons 8 for selecting various functions included in the image processing apparatus 10 and a navigation bar 9 for displaying useful information for the user to perform an operation are displayed. Since the image processing apparatus 10 has the copying function, the printing function, and the scanning function, a copy button 8A for selecting the copying function, a print button 8B for selecting the printing function, and a scan button 8C for selecting the scanning function are displayed on the home screen 30B. The navigation bar 9 displays, for example, the name of the authenticated user such as “user A”, the screen name displayed on the operation panel 15 such as “home”, and information for notifying the user that the operation panel 15 is in the non-contact operation mode such as “Touch Less”.

When the user holds a finger over the copy button 8A and performs a predetermined selection operation, the copy button 8A is selected. When the copy button 8A is selected, a copy screen 30D is displayed on the operation panel 15. On the copy screen 30D, buttons 8D to 8G for setting copy conditions and a copy start button 8H for starting copying under the set copy conditions are displayed. Note that details of the selection operation performed by the user to select an object will be described later.

In the copy screen 30D illustrated in FIG. 5, as examples of the buttons 8 for setting copy conditions, for example, a color mode button 8D for selecting the color of copy, a double-sided/single-sided selection button 8E for selecting a copy side, an N-up button 8F for selecting the method of laying out images on a recording medium, and a number-of-copies button 8G for selecting the number of copies are displayed.

When the user holds a finger over any of the buttons 8 among the buttons 8D to 8G for setting copy conditions and performs a selection operation, the button 8 corresponding to the user's operating position 6 is selected, and the screen 30 for setting copy conditions corresponding to the selected button 8 is displayed. When the double-sided/single-sided selection button 8E is selected on the copy screen 30D, a double-sided/single-sided selection screen 30G for selecting the copy side is displayed on the operation panel 15 in a manner superimposed on the copy screen 30D.

The double-sided/single-sided selection screen 30G illustrated in FIG. 5 displays, for example, a double-sided→double-sided selection button 8S for sequentially copying the contents of both sides of the document 11 to both sides of a recording medium, a single-sided→double-sided selection button 8T for sequentially copying the contents of the document 11 with text and the like written on only one side to both sides of a recording medium, and a single-sided→single-sided selection button 8U for sequentially copying the contents of the document 11 with text and the like written on only one side to one side of a recording medium. When the user holds the finger over any one of the buttons 8S to 8U among the buttons 8S to 8U in the double-sided/single-sided selection screen 30G to perform a selection operation, the button 8 corresponding to the user's operating position 6 is selected, and the copy side corresponding to the selected button 8 is set. The example of the double-sided/single-sided selection screen 30G illustrated in FIG. 5 illustrates a state in which the double-sided→double-sided selection button 8S is selected by the user.

When the copy side is set on the double-sided/single-sided selection screen 30G, a copy screen 30D is displayed on the operation panel 15. Within the double-sided/single-sided selection button 8E of the copy screen 30D after the setting of the copy side, the copy side selected in the double-sided/single-sided selection screen 30G is displayed.

The example in which the user has selected the double-sided/single-sided selection button 8E on the copy screen 30D has been described above. Also in a case where the user selects any one of the color mode button 8D, the N-up button 8F, and the number-of-copies button 8G in the copy screen 30D, a selection screen for selecting copy conditions corresponding to each of the buttons 8, such as the double-sided/single-sided selection screen 30G, is displayed on the operation panel 15.

When the user holds the finger over the copy start button 8H in the copy screen 30D and performs a selection operation, the copy start button 8H is selected. When the copy start button 8H is selected, copy processing for copying the contents of the document 11 to a recording medium is executed in accordance with the set copy conditions. Note that the buttons 8D to 8G on the copy screen 30D before setting the copy conditions display initial settings of preset copy conditions.

On the other hand, when the user holds a finger over the print button 8B and performs a selection operation on the home screen 30B, the print button 8B is selected. When the print button 8B is selected, a print screen 30E is displayed on the operation panel 15.

On the print screen 30E, print information buttons 8J for displaying information of image data to be printed and an all print start button 8M for starting printing of all image data corresponding to each print information button 8J are displayed. The example of the print screen 30E illustrated in FIG. 5 represents the print screen 30E when two pieces of image data to be printed are accepted. That is, the print information buttons 8J corresponding to the respective image data are displayed on the print screen 30E by the number of the image data accepted from the user to be printed.

In a case where there are too many image data to display the corresponding print information buttons 8J at once in the print screen 30E, when the user performs a gesture of moving the finger in an up-and-down direction of the print information buttons 8J, the operation panel 15 detects the movement of the operating position 6 and causes the print information buttons 8J to be scrolled. Thus, the print information buttons 8J that are not fully displayed in the print screen 30E are also displayed in the print screen 30E.

Each of the print information buttons 8J displays a file name of the image data to be printed and print conditions preset by the user for the image data. For example, when a user transmits image data to the image processing apparatus 10 from the terminal 4, print conditions set by the user from the terminal 4 are displayed in the print information buttons 8J.

When the user holds a finger over the all print start button 8M and performs a selection operation, the all print start button 8M is selected. When the all print start button 8M is selected, print processing for printing an image represented by the image data on a recording medium is executed in accordance with the set print conditions.

When the user holds a finger over any one of the print information buttons 8J and performs a selection operation, one of the print information buttons 8J is selected. When one of the print information buttons 8J is selected, a print editing screen 30H is displayed on the operation panel 15. The print editing screen 30H illustrated in FIG. 5 represents a display example when the user selects one of the print information buttons 8J corresponding to the image data of “document B.pdf”.

The print editing screen 30H displays, for example, a delete button 8V to delete the image data corresponding to one of the selected print information buttons 8J, a change button 8W to change the print conditions of the image data corresponding to one of the selected print information buttons 8J, and an individual print start button 8X to print only the image data corresponding to one of the selected print information buttons 8J. On the print editing screen 30H illustrated in FIG. 5, as an example of the change button 8W, the change button 8W for changing the number of copies to be printed is displayed. Note that for example, the change button 8W for changing other print conditions such as the color of an image to be printed is also displayed on the print editing screen 30H, but is not illustrated.

On the other hand, when the user holds a finger over the scan button 8C and performs a selection operation on the home screen 30B, the scan button 8C is selected. When the scan button 8C is selected, a scan screen 30F is displayed on the operation panel 15.

On the scan screen 30F, a scan setting button 8N for setting scan conditions and a scanning start button 8R for starting reading of the document 11 under the set scan conditions are displayed.

When the user holds the finger over the scan setting button 8N and performs a selection operation, the scan setting button 8N corresponding to the operating position 6 of the user is selected, and a selection screen (not illustrated) for selecting a scan condition corresponding to the selected scan setting button 8N is displayed. That is, the user sets the scan condition associated with the scan setting button 8N in the same manner as the operation of setting the copy conditions from the copy screen 30D. When the user holds a finger over the scanning start button 8R and performs a selection operation, the scanning start button 8R is selected. When the scanning start button 8R is selected, scan processing for converting the description content of the document 11 into image data is executed according to the set scan conditions.

On the other hand, when the user holds a finger over the navigation bar 9 and performs a selection operation on the home screen 30B, the navigation bar 9 is selected. When the navigation bar 9 is selected, a logout processing of the authenticated user is performed, and a display indicating that the logout is completed is displayed on the navigation bar 9 as illustrated in a screen 30C.

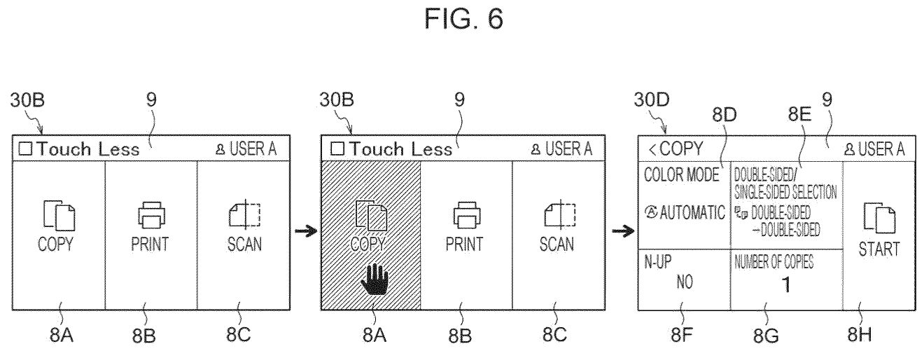

FIG. 6 is a diagram illustrating a selection example in which the user selects the copy button 8A which is an example of the operation object on the home screen 30B. When the user holds the finger over the copy button 8A, the operating position 6 is detected in the display region of the copy button 8A. When the user continues to hold the finger over the copy button 8A and the detected operating position 6 continues to stay in the display region of the copy button 8A for a predetermined time, the copy button 8A is selected as illustrated in FIG. 6 and a copy screen 30D is displayed on the operation panel 15. Each of the operation objects in the screen 30D is associated in advance with processing to be executed when the operation object is selected so that the copy processing is executed when the copy start button 8H is selected. The operation object is displayed on the screen 30D by associating with an item indicating content to be processed. Therefore, each operation object is an example of the “item displayed on the screen” according to the present exemplary embodiment.

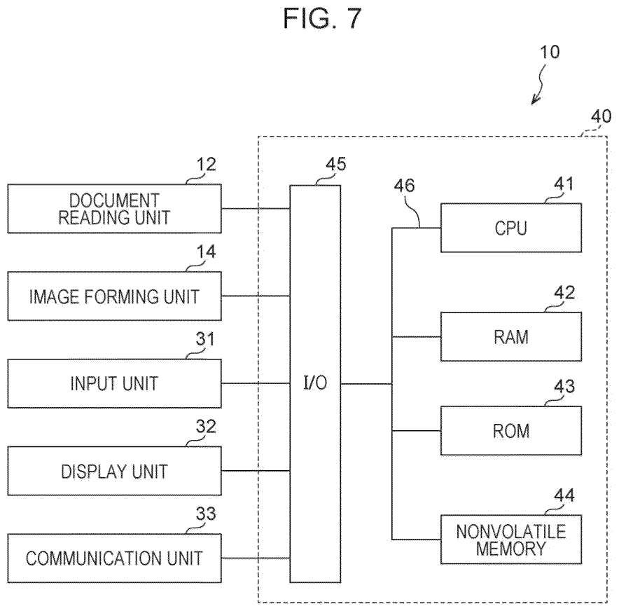

Next, a main part configuration of an electrical system of the image processing apparatus 10 will be described with reference to FIG. 7. The image processing apparatus 10 is configured with, for example, a computer 40.

The computer 40 includes a central processing unit (CPU) 41, a random access memory (RAM) 42, and a read only memory (ROM) 43, a nonvolatile memory 44, and an input/output interface (I/O) 45 are connected to each other via a bus 46.

The CPU 41 is an example of a processor responsible for processing of each functional unit of the image processing apparatus 10 illustrated in FIG. 4. The RAM 42 is an example of a storage medium used as a temporary working area of the CPU 41. The ROM 43 is an example of a storage medium that stores an information processing program executed in the CPU 41. The nonvolatile memory 44 is an example of a storage medium in which stored information is maintained even when power supplied to the nonvolatile memory 44 is cut off and a semiconductor memory is used, for example, but a hard disk may be used. The nonvolatile memory 44 does not necessarily have to be incorporated in the computer 40, and may be a storage medium such as a memory card that is attachable to/detachable from the computer 40. For example, the document reading unit 12, the image forming unit 14, an input unit 31, a display unit 32, and a communication unit 33 are connected to the I/O 45.

The document reading unit 12 and the image forming unit 14 are devices that perform the operations as described above. The input unit 31 is a device that accepts user's instructions and user IDs and notifies to the CPU 41, and the touch panel constituting the operation panel 15 and the reader device 17 are examples of the input unit 31. The display unit 32 is a device that visually displays information processed by the CPU 41, and the display constituting the operation panel 15 is an example of the display unit 32. The communication unit 33 is connected to the communication line 2 and has a communication protocol for performing communication with the terminal 4. Note that the units connected to the I/O 45 are not limited to the units illustrated in FIG. 7. Depending on the functions included in the image processing apparatus 10, units necessary for realizing the functions are connected to the I/O 45.

Next, a predetermined selection operation for selecting an object in the image processing apparatus 10 according to the present exemplary embodiment will be described. Examples of the object selection operation of the image processing apparatus 10 include an operation of selecting an object by keeping the user's finger on the object for a certain period of time, and an operation of selecting an object by moving the user's finger closer to or away from the object. In the present exemplary embodiment, as an example, an operation of selecting an object by keeping the user's finger on the object for a certain period of time is adopted.

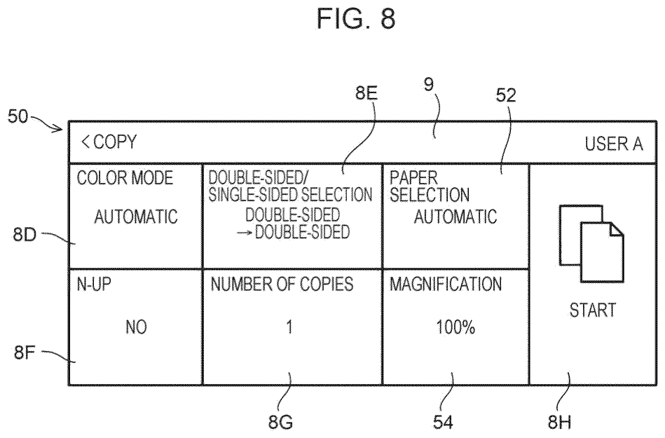

Hereinafter, an object selection operation will be described with reference to a copy screen 50 illustrated in FIG. 8 as an example.

On the copy screen 50 illustrated in FIG. 8, as examples of the objects, the color mode button 8D, the double-sided/single-sided selection button 8E, a paper selection button 52, the N-up button 8F, the number-of-copies button 8G, a magnification button 54, and the copy start button 8H are displayed. Note that the copy screen 50 is an example in which the magnification button 54 and the paper selection button 52 are added to the copy screen 30D illustrated in FIG. 5, and the other configuration is the same as that of the copy screen 30D. Therefore, the paper selection button 52 and the magnification button 54 will be described here.

The paper selection button 52 is a button having a function of selecting a sheet of paper to be printed. When the paper selection button 52 is selected, the screen transitions to a screen (not illustrated) for setting a sheet of paper (paper size) to be printed.

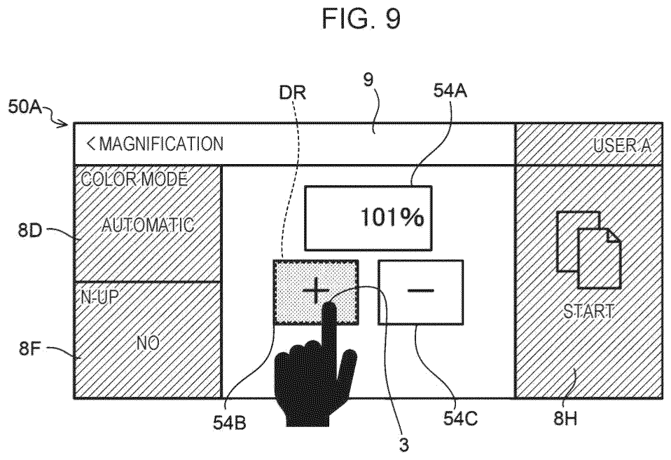

The magnification button 54 is a button with the function of selecting printing magnification of a printing target. When the magnification button 54 is selected, the screen transitions to a screen for setting the printing magnification (see FIG. 9).

Here, in a case where the magnification button 54 is selected on the copy screen 50, a printing magnification selection screen 50A for selecting printing magnification is displayed on the operation panel 15 in a superimposed manner on the copy screen 50.

On the printing magnification selection screen 50A illustrated in FIG. 9, a window 54A for displaying the printing magnification, an up button 54B for increasing the printing magnification, and a down button 54C for decreasing the printing magnification are displayed. Note that the up button 54B and the down button 54C are examples of objects.

When the user performs a selection operation by holding the finger over one of the up button 54B and the down button 54C, the button corresponding to the operating position 6 of the user is selected, and processing corresponding to the selected button is executed. Here, when the up button 54B is selected, the printing magnification is increased. On the other hand, when the down button 54C is selected, the printing magnification is decreased. The increase or decrease of the printing magnification is displayed in the magnification display of the window 54A.

Next, an example of a non-contact operation of the image processing apparatus 10 according to the present exemplary embodiment will be described with reference to FIGS. 9 to 13.

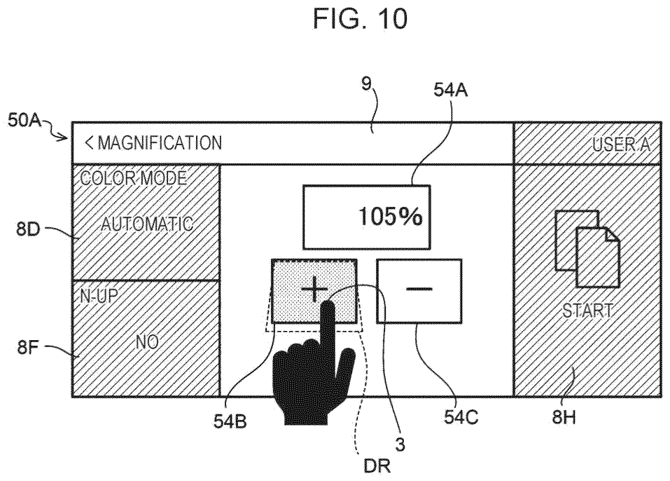

In the present exemplary embodiment, as illustrated in FIG. 9, in a case where the non-contact operation is performed by the user's finger 3 on an object in the printing magnification selection screen 50A, when the user's finger 3 is detected in a detection region included in a display region in which the object is displayed in the printing magnification selection screen 50A, the CPU 41 expands the detection region to outside the display region (see FIG. 10). Specifically, when the user's finger 3 is on the object in the printing magnification selection screen 50A, in other words, when the object is at the operating position 6, the CPU 41 expands a detection region DR of the object in the printing magnification selection screen 50A to outside the display region of the object. To be more specific, when the user's finger 3 is on the up button 54B in the printing magnification selection screen 50A, in other words, when the up button 54B is at the operating position 6, the CPU 41 expands the detection region DR of the up button 54B in the printing magnification selection screen 50A to outside the display region of the up button 54B.

In the present exemplary embodiment, the detection region DR is included in the display region of the object, but the display region of the object and the detection region DR may be the same.

Here, as illustrated in FIG. 10, the CPU 41 may expand the detection region DR downward with respect to the display region of the object. Specifically, the CPU 41 expands the detection region DR downward with respect to the display region of the up button 54B. To be more specific, the CPU 41 may expand the detection region DR with respect to the display region of the up button 54B to spread out wide downward. That is, the CPU 41 may spread the width of the detection region DR downward. In the present exemplary embodiment, as an example, the detection region DR is expanded in a trapezoidal shape.

Further, as illustrated in FIG. 9, the CPU 41 may change at least one of the color and the shape of the object when the user's finger 3 is detected in the detection region DR for a predetermined time. Specifically, the CPU 41 may change the color of the up button 54B when the user's finger 3 is detected for a predetermined time in the detection region DR of the up button 54B. In the present exemplary embodiment, as an example, the color of the up button 54B is changed. Note that the present disclosure is not limited to this configuration. The CPU 41 may change the shape of the object when the user's finger 3 is detected in the detection region DR for a predetermined time. Specifically, an outer shape of the object may be changed. A frame indicating the outer shape of the object may be multiple frames. Further, the CPU 41 may change the shape of the object while changing the color of the object.

Further, when the user's finger 3 is detected in the detection region DR for a predetermined time, the CPU 41 may confirm the operation on the object. Specifically, the user's finger 3 is detected in the detection region DR of the up button 54B for a predetermined time, the CPU 41 may select the up button 54B and confirm the operation of the selected up button 54B. When the operation of the up button 54B is confirmed, processing of increasing the printing magnification is executed.

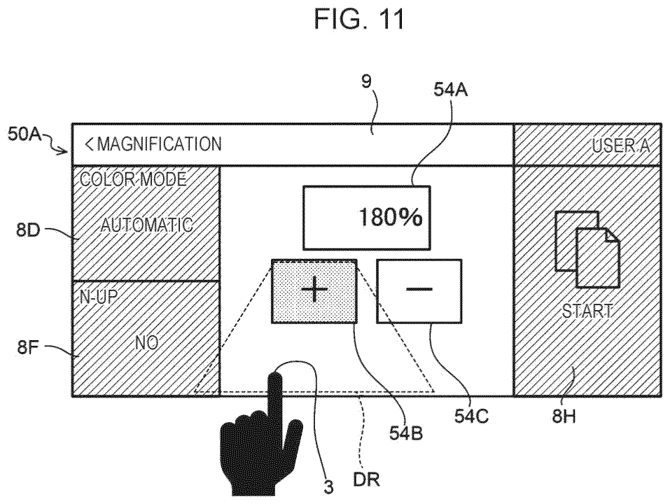

Further, as illustrated in FIG. 11, the CPU 41 may expand the detection region DR in accordance with the detection time of the user's finger 3. In other words, the CPU 41 may gradually expand the detection region DR in accordance with the detection time of the user's finger 3. In the present exemplary embodiment, as an example, the detection region DR gradually expands downward. Note that the detection region DR may spread downward in a similar shape or in a shape different from the similar shape. Further, the detection time may be set to, for example, one second, or the like.

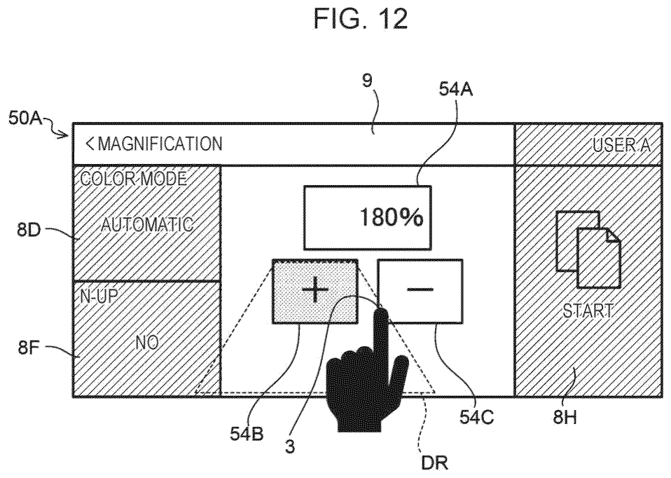

Further, as illustrated in FIG. 12, when a plurality of objects are displayed in the copy screen 50, the CPU 41 stops accepting operations on objects other than the object being operated. Specifically, when the up button 54B is being selected, the CPU 41 does not accept the selection operation of the down button 54C even when the user's finger 3 is on the down button 54C.

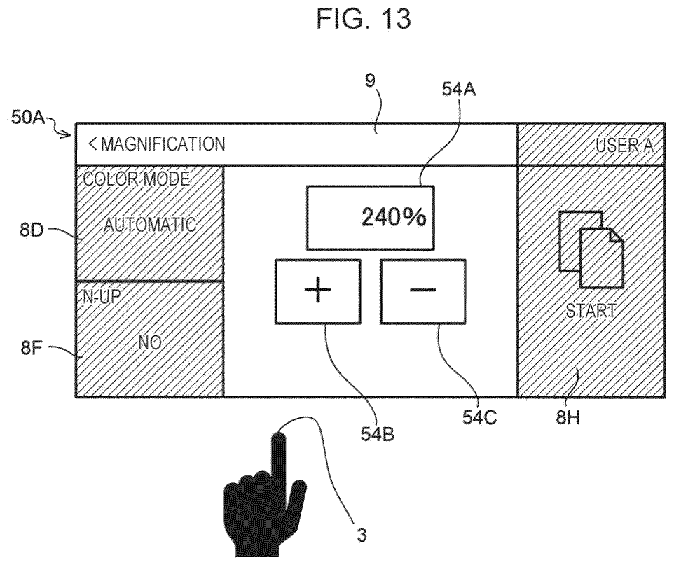

Further, as illustrated in FIG. 13, when the user's finger 3 moves out of the detection region DR of the object being operated, the CPU 41 stops the operation of the object. Specifically, when the user's finger 3 moves from the detection region DR of the up button 54B being operated to the outside of the region, the CPU 41 stops the process of increasing the printing magnification. Similarly, when the user's finger 3 moves too far away from the operation panel 15, the user's finger 3 is no longer detected, and thus processing of increasing the printing magnification is stopped.

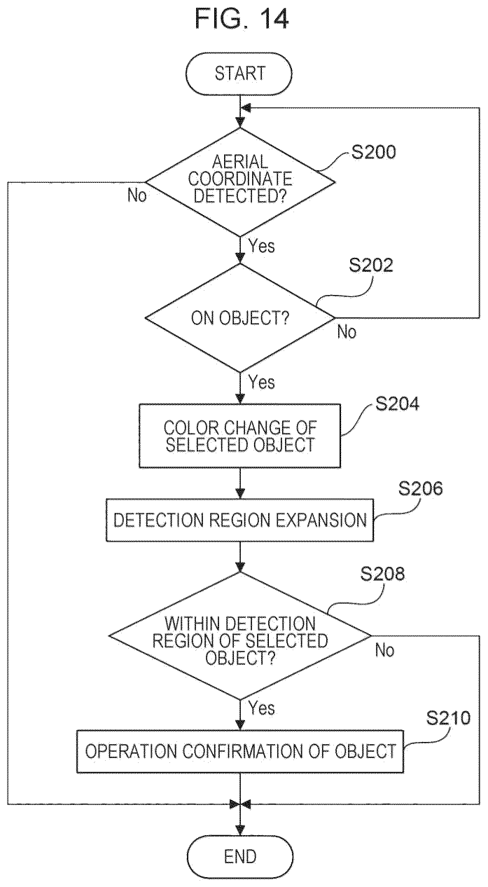

Next, description will be given of operation of the image processing apparatus 10 of the present exemplary embodiment with reference to FIG. 14.

FIG. 14 is a flowchart illustrating an example of process flow performed by an information processing program according to the present exemplary embodiment.

First, when execution of non-contact input on the operation panel 15 is instructed, the information processing program is activated by the CPU 41 to execute the following steps. Note that the process flow for selecting an object on the copy screen 50 and executing allocated processing will be described below.

In step S200, the CPU 41 determines whether or not current finger coordinates (aerial coordinates) of the user's finger 3, which is the target object to perform a non-contact operation, can be detected. If the user's finger 3 cannot be detected, the current process is terminated. In a case where the finger coordinates of the user's finger 3 are detected, the process proceeds to step S202.

In step S202, the CPU 41 determines whether or not the user's finger 3 is on an object. When the user's finger 3 is on an object, the process proceeds to step S204. On the other hand, when the user's finger 3 of the user is not on the object, the CPU 41 determines that the object is being selected, and returns to step S200.

In step S204, the CPU 41 changes the color of the object on which the user's finger 3 is present (for example, see FIG. 9). Note that the shape of the object on which the user's finger 3 is present may be changed, or both the color and the shape of the object may be changed.

In step S206, the CPU 41 expands the detection region DR of the selected object (for example, see FIG. 10 and FIG. 11). Note that the detection region DR of the object may be gradually expanded or may be expanded at a time.

In step S208, the CPU 41 determines whether or not the user's finger 3 is present within the detection region DR of the selected object. When the user's finger 3 is present in the detection region DR, the process proceeds to step S210. On the other hand, when the user's finger 3 is not present in the detection region DR, that is, when the user's finger 3 is present in the outside of the detection region, the current process ends.

In step S210, the CPU 41 confirms the operation of the object. Specifically, as illustrated in FIGS. 10 and 11, when the operation of the up button 54B is confirmed, the display of the printing magnification increases. After the printing magnification is increased, the current process ends. Note that the printing magnification can be increased or decreased by repeating the current process.

In the present exemplary embodiment, when a non-contact operation is performed by the user's finger 3 on an object within the screen (as an example, the copy screen 50), when the CPU 41 detects the user's finger 3 in the detection region DR, the detection region DR is expanded to outside the display region of the object. This allows the detection state (selection state) of the user's finger 3 to be continued, as compared with the case where the detection region DR remains within the display region when the user's finger 3 is detected in the detection region DR of the object operated in a non-contact manner. That is, as illustrated in FIG. 11, even when the user's finger 3 is shifted from the initial detection region, the detection state of the user's finger 3 can be continued by the expansion of the detection region DR.

In the present exemplary embodiment, when the CPU 41 expands the detection region DR in accordance with the detection time of the user's finger 3, the detection state of the user's finger 3 can be continued, as compared with the case where the size of the detection region DR is always constant after being expanded once. That is, since the detection region DR expands, the user's finger 3 is less likely to move out of the detection region DR.

In the present exemplary embodiment, when the CPU 41 expands the detection region DR downward with respect to the display region of the object, the detection state of the user's finger 3 can be continued even when the position of the user's finger 3 shifts downward due to weight thereof, as compared with the case where the detection region DR is expanded upward with respect to the display region.

In the present exemplary embodiment, when the CPU 41 expands the detection region DR to spread out wide downward, the detection state of the user's finger 3 can be continued, even when the position of the user's finger 3 is shifted obliquely downward due to weight thereof, as compared with the case where the detection region DR is expanded downward with a constant width.

In the present exemplary embodiment, in a case where the user's finger 3 in the detection region DR is detected for a predetermined time, the CPU 41 confirms the operation on the object, so that the user's erroneous operation can be suppressed, as compared with the case where the operation on the object is confirmed when the user's finger 3 is detected in the detection region DR.

In the present exemplary embodiment, in a case where a plurality of objects are displayed on the screen, the CPU 41 stops the acceptance of an operation on an object other than the object being operated, so that an erroneous operation of the user can be suppressed, as compared with the case where an operation on an object other than the object being operated is accepted.

In the present exemplary embodiment, in a case where the CPU 41 stops the operation when the user's finger 3 moves to the outside of the detection region DR of the object being operated, the erroneous operation of the user can be suppressed, as compared with the case where the operation is continued even when the user's finger 3 moves to the outside of the detection region DR of the object being operated.

In the present exemplary embodiment, in the case where the CPU 41 changes at least one of the color and the shape of the object when the user's finger 3 is detected in the detection region DR for a predetermined time, the user can easily recognize the object detected by the CPU 41, as compared with the case where the display mode of the object is maintained even when the user's finger 3 is detected in the detection region DR for a predetermined time.

### OTHER EXEMPLARY EMBODIMENTS

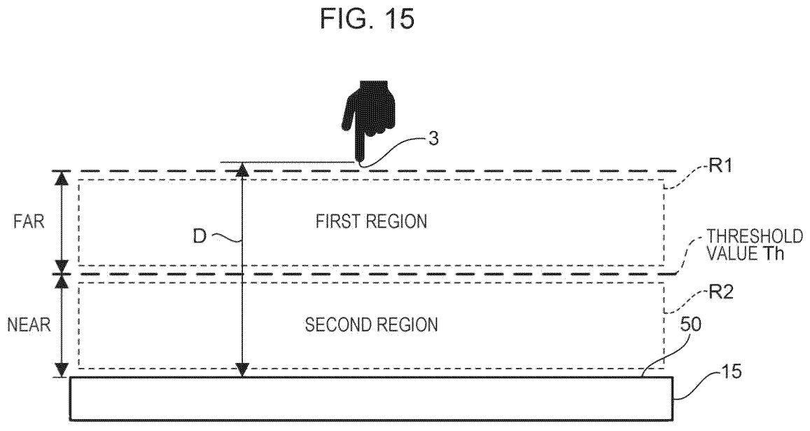

In the above-described exemplary embodiment, when the user's finger 3 is detected in a detection region DR of the object for a predetermined time, the CPU 41 selects the object to be targeted and executes processing set for the object, but the present disclosure is not limited to this configuration. For example, selection of an object and confirmation of an operation allocated to the selected object (execution of processing) may be switched in accordance with the distance of the user's finger 3 from the operation panel 15. Specifically, as illustrated in FIG. 15, the distance from the user's finger 3 to the operation panel 15 (that is, the operation distance D) are divided into two regions, and one of the two regions that is located on the side of the user's finger 3 is defined as a first region R1, and the other region that is located on the side of the operation panel 15 relative to the first region R1 is defined as a second region R2. Note that the first region R1 and the second region R2 are separated by a threshold value Th. The threshold value Th is a threshold value for the distance from the operation panel 15 to the user's finger 3, and may be set to an appropriate value within a range that does not exceed the distance at which the user's finger 3 can be detected. Then, an object selection operation is associated with the first region R1 and confirmation of an operation allocated to the selected object is associated with the second region R2, so that selection of an object and confirmation of an operation allocated to the selected object can be switched in accordance with the distance of the user's finger 3 from the operation panel 15. Note that when explaining the above printing magnification as an example, when the user's finger 3 is in the first region R1, either the up button 54B or the down button 54C can be selected. When a user presses the user's finger 3 on the up button 54B or the down button 54C, that is, presses toward a side of the operation panel 15, the operation of the selected button is confirmed and the printing magnification is increased or decreased. As described above, when the CPU 41 switches the selection of the object and the confirmation of the operation allocated to the selected object according to the distance of the user's finger 3 from the operation panel 15, the user's erroneous operation can be suppressed, as compared with the case where the selection and the confirmation of the operation are switched in accordance with the detection time of the user's finger 3.

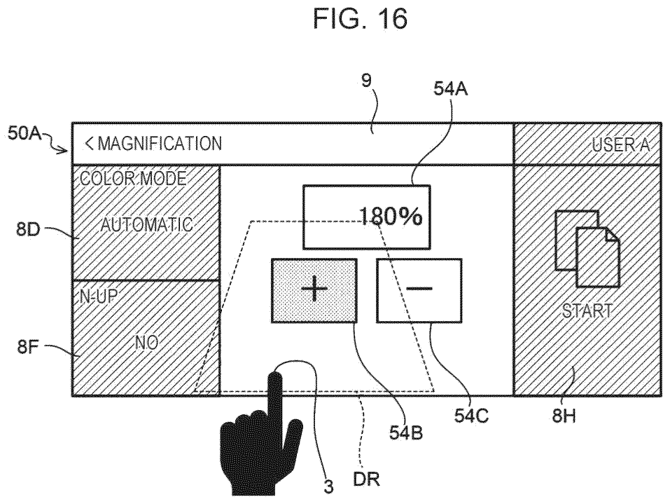

Although the CPU 41 expands the detection region DR downward with respect to a display region of the object in the above-described exemplary embodiment, the present disclosure is not limited to this configuration. For example, the CPU 41 may expand the detection region DR upward, leftward, and rightward with respect to the display region of the object. Further, the detection region DR may be expanded in a combination of two or more of the upward, downward, leftward, and rightward directions with respect to the display region of the object. The CPU 41 may expand the entire detection region DR with respect to the display region of the object to outside the display region of the object. Note that taking the above-described printing magnification as an example, for example, as illustrated in FIG. 16, the CPU 41 may expand the entire detection region DR with respect to the display region of the up button 54B. In this way, when the CPU 41 expands the entire detection region DR with respect to the display region of the up button 54B, the detection state of the user's finger 3 can be continued even when the position of the user's finger 3 is shifted to the outside of the display region, as compared with the case where only a part of the detection region DR is expanded to outside the display region.

Although the CPU 41 expands the detection region DR in accordance with the detection time of the user's finger 3 in the above-described exemplary embodiment, the present disclosure is not limited to this configuration. For example, the CPU 41 may change the shape of the detection region DR in accordance with distance from a screen. Specifically, as the user's finger 3 approaches the operation panel 15, the detection region DR may be gradually expanded. As in the example illustrated in FIG. 15, a configuration may be adopted in which the detection region DR expands when the user's finger 3 moves from the first region R1 to the second region R2. In this case, as compared with the case where the shape of the detection region DR is constant regardless of the distance of the user's finger 3 from the operation panel 15, the detection state of the user's finger 3 is easy to continue.

In each of the above exemplary embodiments, the processor refers to a processor in a broad sense, and includes general-purpose processors (for example, a central processing unit (CPU), and the like) and dedicated processors (for example, a graphics processing unit (GPU), an application specific integrated circuit (ASIC), a field programmable gate array (FPGA), a programmable logic device, and the like).

In addition, the operation of the processor in each of the above-described exemplary embodiments may be performed not only by one processor but also by a plurality of processors existing at physically separated positions in cooperation with each other. In addition, the order of the respective operations of the processor is not limited to only the order described in the respective exemplary embodiments described above, but may be appropriately changed.

The image processing apparatus has been described above as an example of the information processing apparatus according to the exemplary embodiment. The exemplary embodiment may be in the form of a program for causing a computer to execute the functions of the information processing apparatus. The exemplary embodiment may be in the form of a non-transitory computer-readable storage medium storing these programs.

In addition, the configuration of the information processing apparatus described in the above-described exemplary embodiment is an example, and may be changed according to a situation without departing from the scope of the exemplary embodiment of the invention.

The process flow of the program described in the above-described exemplary embodiment is also an example, and an unnecessary step may be deleted, a new step may be added, or the processing order may be changed without departing from the scope of the exemplary embodiment of the invention.

In the above-described exemplary embodiment, the case where the processing according to the exemplary embodiment is achieved by a software configuration using a computer by executing a program has been described, but the exemplary embodiment is not limited thereto. The exemplary embodiment may be achieved by, for example, a hardware configuration or a combination of a hardware configuration and a software configuration.

### APPENDIX

(((1)))

An information processing system comprising:
a processor configured to:
   in a case where a non-contact operation by a target object is performed on an object within a screen, when the target object is detected in a detection region included in a display region in which the object is displayed within the screen, expand the detection region to outside the display region.
      (((2)))

The information processing system according to (((1))), wherein the processor is configured to expand the detection region in accordance with a detection time of the target object.

(((3)))

The information processing system according to (((1))) or (((2))), wherein the processor is configured to expand the detection region downward with respect to the display region.

(((4)))

The information processing system according to (((3))), wherein the processor is configured to expand the detection region to spread out wide downward.

(((5)))

The information processing system according to any one of (((1))) to (((4))), wherein the processor is configured to expand the entirety of the detection region to outside the display region.

(((6)))

The information processing system according to any one of (((1))) to (((5))), wherein the processor is configured to change a shape of the detection region in accordance with a distance of the target object from the screen.

(((7)))

The information processing system according to any one of (((1))) to (((6))), wherein the processor is configured to confirm an operation on the object when the target object is detected in the detection region for a predetermined time.

(((8)))

The information processing system according to (((7))), wherein the processor is configured to, when a plurality of objects are displayed in the screen, stop acceptance of an operation on an object other than the object being operated.

(((9)))

The information processing system according to (((7))) or (((8))), wherein the processor is configured to stop an operation when the target object moves out of the detection region of the object being operated.

(((10)))

The information processing system according to (((7))) or (((8))), wherein the processor is configured to change at least one of a color and a shape of the object when the target object is detected in the detection region for a predetermined time.

(((11)))

The information processing system according to any one of (((1))) to (((6))), wherein the processor is configured to switch between selection of the object and confirmation of an operation allocated to the selected object in accordance with a distance of the target object from the screen.

(((12)))

A program causing a computer to execute a process for information processing, the process comprising:
in a case where a non-contact operation by a target object is performed on an object within a screen, when the target object is detected in a detection region included in a display region in which the object is displayed within the screen, expanding the detection region to outside the display region.
   (((13)))

An information processing method to be executed by a computer, the information processing method comprising:
in a case where a non-contact operation by a target object is performed on an object within a screen, when the target object is detected in a detection region included in a display region in which the object is displayed within the screen, expanding the detection region to outside the display region.

What is claimed is:

1. An information processing system comprising:
a processor configured to:
in a case where a non-contact operation by a target object is performed on an object within a screen, when the target object is detected in a detection region included in a display region in which the object is displayed within the screen, expand the detection region to outside the display region.

2. The information processing system according to claim 1, wherein the processor is configured to expand the detection region in accordance with a detection time of the target object.

3. The information processing system according to claim 1, wherein the processor is configured to expand the detection region downward with respect to the display region.

4. The information processing system according to claim 2, wherein the processor is configured to expand the detection region downward with respect to the display region.

5. The information processing system according to claim 3, wherein the processor is configured to expand the detection region to spread out wide downward.

6. The information processing system according to claim 4, wherein the processor is configured to expand the detection region to spread out wide downward.

7. The information processing system according to claim 1, wherein the processor is configured to expand the entirety of the detection region to outside the display region.

8. The information processing system according to claim 2, wherein the processor is configured to expand the entirety of the detection region to outside the display region.

9. The information processing system according to claim 1, wherein the processor is configured to change a shape of the detection region in accordance with a distance of the target object from the screen.

10. The information processing system according to claim 2, wherein the processor is configured to change a shape of the detection region in accordance with a distance of the target object from the screen.

11. The information processing system according to claim 1, wherein the processor is configured to confirm an operation on the object when the target object is detected in the detection region for a predetermined time.

12. The information processing system according to claim 11, wherein the processor is configured to, when a plurality of objects are displayed in the screen, stop acceptance of an operation on an object other than the object being operated.

13. The information processing system according to claim 11, wherein the processor is configured to stop an operation when the target object moves out of the detection region of the object being operated.

14. The information processing system according to claim 12, wherein the processor is configured to stop an operation when the target object moves out of the detection region of the object being operated.

15. The information processing system according to claim 11, wherein the processor is configured to change at least one of a color and a shape of the object when the target object is detected in the detection region for a predetermined time.

16. The information processing system according to claim 12, wherein the processor is configured to change at least one of a color and a shape of the object when the target object is detected in the detection region for a predetermined time.

17. The information processing system according to claim 1,
wherein the processor is configured to switch between selection of the object and confirmation of an operation allocated to the selected object in accordance with a distance of the target object from the screen.

18. A non-transitory computer readable medium storing a program causing a computer to execute a process for information processing, the process comprising:
in a case where a non-contact operation by a target object is performed on an object within a screen, when the target object is detected in a detection region included in a display region in which the object is displayed within the screen, expanding the detection region to outside the display region.

19. An information processing method to be executed by a computer, the information processing method comprising:
in a case where a non-contact operation by a target object is performed on an object within a screen, when the target object is detected in a detection region included in a display region in which the object is displayed within the screen, expanding the detection region to outside the display region.
